(19) United States
(12) Patent Application Publication
(10) Pub. No.: US 2023/0177543 A1
(43) Pub. Date: Jun. 8, 2023

(54) PRIVACY PRESERVING MACHINE LEARNING EXPANSION MODELS

(71) Applicant: Google LLC, Mountain View, CA (US)

(72) Inventors: Wei Huang, Kirkland, WA (US); Zhenyu Liu, San Jose, CA (US); Geoffrey Charles Levine, San Jose, CA (US); Deepa Paranjpe, Palo Alto, CA (US); Yipei Wang, Sunnyvale, CA (US); Robert Istvan Busa-Fekete, Chatham, NJ (US)

(21) Appl. No.: 17/543,465

(22) Filed: Dec. 6, 2021

(51) Int. Cl. G06Q 30/02; G06Q 30/06; G06N 20/00

(52) U.S. Cl. CPC G06Q 30/0205; G06Q 30/0631; G06N 20/00

(57) ABSTRACT

Methods, systems, and apparatus, including computer programs encoded on a computer storage medium, for using machine learning models to expand user groups while preserving user privacy and data security are described. In one aspect, a method includes receiving, for a web-based resource, a set of user group identifiers for a set of user interest groups that each include, as members, one or more users that requested content from the web-based resource over a given time period. A seed user list that includes user identifiers for at least a portion of the users in the set of user interest groups is created. A similar audience machine learning model is generated based on a set of one or more feature values corresponding to one or more features of the users corresponding to the user identifiers in the seed user list. A set of similar users is identified using the model.

### TECHNICAL FIELD

This specification relates to data processing and machine learning.

### BACKGROUND

A client device can use an application (e.g., a web browser, a native application) to access a content platform (e.g., a search platform, a social media platform, or another platform that hosts content). The content platform can display, within an application launched on the client device, digital components (a discrete unit of digital content or digital information such as, e.g., a video clip, an audio clip, a multimedia clip, an image, text, or another unit of content) that may be provided by one or more content source/platform.

### SUMMARY

This specification is related to data processing and machine learning. Machine learning models can be trained to identify similar users and then used to customize content for users in ways that preserve user privacy and maintain data security.

In general, one innovative aspect of the subject matter described in this specification can be embodied in methods that include receiving, for a web-based resource, a set of user group identifiers for a set of user interest groups that each include, as members, one or more users that requested content from the web-based resource over a given time period. Each user interest group includes multiple users that have been classified as being interested in a category of the user interest group. A seed user list that includes user identifiers for at least a portion of the users in the set of user interest groups is created. A similar audience machine learning model is generated based on a set of one or more feature values corresponding to one or more features of the users corresponding to the user identifiers in the seed user list. A set of similar users that are classified as being similar to the users corresponding to the user identifiers in the seed user list is identified using the similar audience machine learning model. An expanded user list is generated to include the user identifiers of the seed user list and the user identifiers of the set of similar users. Digital content related to the web-based resource is distributed to the users corresponding to the user identifiers in the expanded user list based on the users being in the expanded user list. Other implementations of this aspect include corresponding apparatus, systems, and computer programs, configured to perform the aspects of the methods, encoded on computer storage devices.

These and other implementations can each optionally include one or more of the following features. In some aspects, receiving the set of user group identifiers includes receiving, from a client device, a request for content of the web-based resource, providing, to the client device, the content comprising code that causes the client device to return a user group identifier for a user group that includes a user of the client device as a member, and in response to the user requesting the content of the web-based resource, adding, to the set of user group identifiers, the user group identifier for the user group that includes the user of the client device as a member.

In some aspects, the similar audience model includes at least one of a neural network, a centroid model, or a k-nearest neighbors model. Creating a seed user list can include determining, for each user interest group in the set of user interest groups, a quantity of requests for content the web-based resource received from members of the user interest group over the given time period, selecting a proper subset of the set of user interest groups based on the quantity for each user interest group in the set of user interest groups, and including, in the seed user list, each user identifier of each user interest group in the subset of user interest groups.

In some aspects, generating the similar audience machine learning model based on the set of one or more feature values corresponding to one or more features of the users corresponding to the user identifiers in the seed user list can include identifying, for each user interest group, a respective feature value for a respective feature of the user interest group based on the feature values for the users in the user interest group and training the similar audience machine learning model using the respective feature value for each user interest group in the set of user interest group.

In some aspects, generating the similar audience machine learning model based on the set of one or more feature values corresponding to one or more features of the users corresponding to the user identifiers in the seed user list includes identifying all feature values of all users in the seed user list and training the similar audience machine learning model using all feature values of all users in the seed user list.

In some aspects, generating the similar audience machine learning model based on the set of one or more feature values corresponding to one or more features of the users corresponding to the user identifiers in the seed user list includes generating, for a given user interest group, multiple clusters of users based on feature values for each user that is a member of the given user interest group, generating, for each cluster, a respective feature value for a feature of the cluster, a d training the similar audience machine learning model using the feature value for each cluster.

The subject matter described in this specification can be implemented in particular embodiments so as to realize one or more of the following advantages. The techniques described in this document can create and expand user groups in ways that preserve user privacy, while improving content selection and distribution using limited amounts of data. The user groups can be created and expanded without the need to send users' online activity to content platforms or otherwise leak the users' cross-domain online activity to other computing systems or parties or use the users' cross-domain private information to expand user group membership. This protects user privacy with respect to such platforms and preserves the security of the data from breaches during transmission to or from the platforms.

Historically, third-party cookies (e.g., cookies from a different domain than the resource being rendered by a client device) have been used to collect data from client devices across the Internet. However, some browsers block the use of third-party cookies and third-party cookies are increasingly being removed from use, thereby preventing the collection of data using third-party cookies. This creates a problem when attempting to utilize collected data to segment data, make inferences, or otherwise utilize data to enhance online browsing experiences. In other words, without the use of third-party cookies, much of the data previously collected is no longer available, which prevents computing systems from being able to use that data to group users based on shared interests, activities performed by the users at particular web pages or other resources, to enhance the online experience for users, and/or to transmit relevant digital components to larger groups of users.

The techniques described herein can solve hurdles that may arise from the eradication of third-party cookies. For example, the disclosed techniques can provide for anonymizing user information, and assigning user identifiers of users to user interest groups that can be used to associate users within the groups as having similar interests. The disclosed techniques can also provide for expanding user groups based on the user interest groups of which members visit and/or perform particular actions at web-based resources, such as websites. Thus, the disclosed techniques can provide for delivery of relevant digital components to large groups of users sharing similar interests without the use of third-party cookies.

The disclosed techniques can preserve privacy of users. Grouping users into interest groups can be performed on-device rather than broadcasted over the Internet or another network. Private or personal information of the users may not be divulged over network connections, nor may private or personal information be used in grouping users based on interests. These techniques can therefore preserve user privacy and protect the security of data, e.g., personal information.

Machine learning models can be trained to identify users that are similar to users in a seed user list, the results of which can be used to expand a user group that includes the users in the seed user list to also include at least some of the similar users without the use of third-party cookies or cross-domain activity of users. In this way, user groups can be expanded to include similar users without transmitting third-party cookies across a public network, e.g., the Internet. By doing so, user privacy is protected, network bandwidth is reduced, computational resources of the client device that would typically send the cookies and of the server that would receive and process the cookies is reduced, and battery power of the client devices is preserved. The expanded user group can then be used to select and distribute content rather than third-party cookies, which provides similar advantages at content selection time. Obviating the need for third-party cookies in this way can reduce/prevent delays in sending content to client devices. Delays in providing content, e.g., digital components, in response to requests can result in page load errors at the client devices or cause portions of an electronic document to remain unpopulated even after other portions of the electronic document are presented at the client devices. Also, as the delay in providing the digital component to the client device increases, it is more likely that the electronic document will no longer be presented at the client device when the digital component is delivered to the client device, thereby negatively impacting a user's experience with the electronic document. Further, delays in providing the digital component can result in a failed delivery of the digital component, for example, if the electronic document is no longer presented at the client device when the digital component is provided.

Various features and advantages of the foregoing subject matter are described below with respect to the figures. Additional features and advantages are apparent from the subject matter described herein and the claims.

### BRIEF DESCRIPTION OF THE DRAWINGS

FIG. 1 is a block diagram of an environment in which a content platform expands user groups and distributes content based on the expanded user groups.

FIG. 2 is a swim lane diagram that illustrates an example process for expanding a user group and distributing content based on the expanded user group.

FIG. 3 is a flow diagram of an example process for expanding a user group and distributing digital components using the expanded user list.

FIG. 4 is a block diagram of an example computer system.

Like reference numbers and designations in the various drawings indicate like elements.

### DETAILED DESCRIPTION

This document describes systems and techniques that utilize data processing models, e.g., machine learning models, for generating and expanding user groups while preserving user privacy and ensuring data security, even in situations where third-party cookies are blocked or otherwise eradicated, and/or collection of user profiles is infeasible due to a variety of reasons. In general, rather than processing user information at computing systems of other entities, such as content platforms or web servers, user information related to resources visited by the users can be processed at the client devices of the users. User privacy can be preserved by grouping users into larger, anonymous groups, which are referred to herein as user interest groups. Each anonymous user interest group can be related to a particular category and have a shared user group identifier, which can be used to identify the user interest group that includes the user as a member rather than identifying the actual user. For example, when requesting customized content or a digital component for a user, the client device can send the user group identifier rather than a user identifier that identifies the user with the request. In this way, the particular category of the user interest group can be used to customize the content or selection of a digital component.

The data related to membership of user interest groups can be used to train machine learning models to generate expanded user lists that include users that are considered to be similar or share similar characteristics. A user group can include users that performed one or more particular actions and/or users that are considered to be similar to the users that performed the one or more particular actions. For example, there can be a user list that includes users that visited a particular electronic resource, e.g., web page, or performed a particular action at the electronic resource, e.g., selected an item at the electronic resource. The techniques described in this document can leverage the membership of user interest groups to generate and/or expand such user lists to include similar users while preserving user privacy and maintaining data security.

In a particular example, a system can maintain a count of the number of times a member of a user interest group performs a particular action that corresponds to another user group, e.g., a user action group. The system can do this without receiving information identifying the users that actually perform the particular action. The system can also obtain data that identifies, for a set of users, the user group to which each user in the set of users belongs. For example, the system can correlate user identifiers for these users to their user groups when the users are logged into a service provided by the system. The system can generate, e.g., train, one or more similar audience models to identify, for each user action group, users that are similar to the members of the user interest group(s) that include users that performed the particular action(s) for the user action group. The system can generate the model(s) using the information about the users that are included in the user interest group that has members that performed the particular action(s). The system can then generate expanded user lists that include similar users using the model(s) and use the user lists to provide customized content, e.g., digital components.

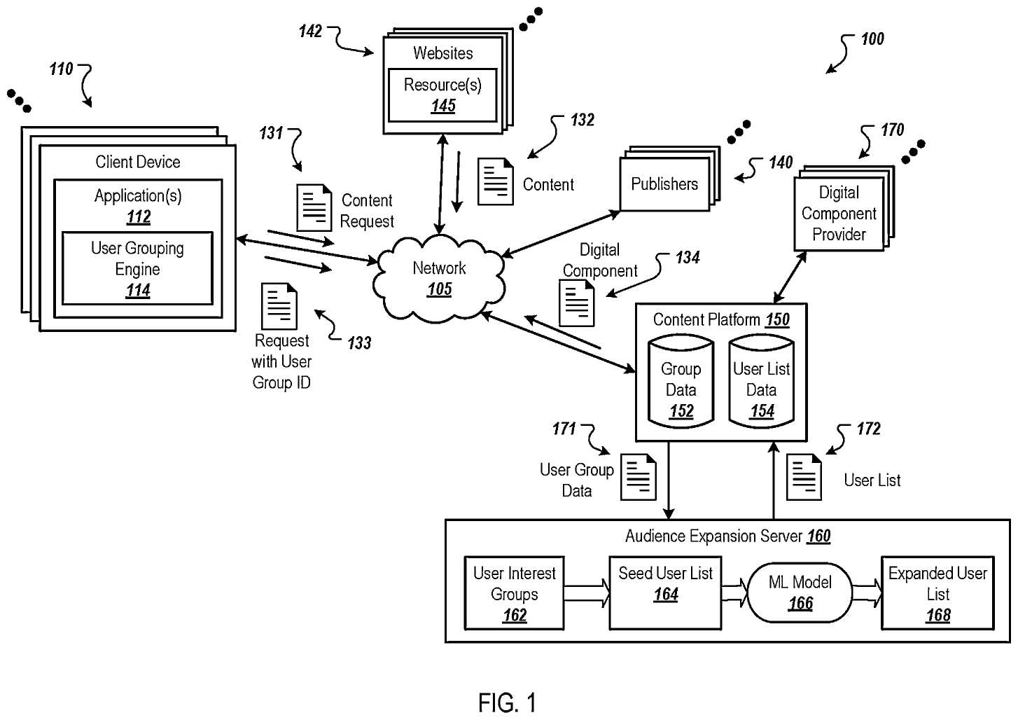

FIG. 1 is a block diagram of an environment 100 in which a content platform 150 expands user groups and distributes content based on the expanded user groups. The example environment 100 includes a data communication network 105, such as a local area network (LAN), a wide area network (WAN), the Internet, a mobile network, or a combination thereof. The network 105 connects the client devices 110, publishers 140, websites 142, and a content platform 150. The example environment 100 may include many different client devices 110, publishers 140, websites 142, and content platforms 150. The content platform 150 can include or be connected to an audience expansion server 160.

A client device 110 is an electronic device that is capable of communicating over the network 105. Example client devices 110 include personal computers, mobile communication devices, e.g., smart phones, and other devices that can send and receive data over the network 105. A client device can also include a digital assistant device that accepts audio input through a microphone and outputs audio output through speakers. The digital assistant can be placed into listen mode (e.g., ready to accept audio input) when the digital assistant detects a “hotword” or “hotphrase” that activates the microphone to accept audio input. The digital assistant device can also include a camera and/or display to capture images and visually present information. The digital assistant can be implemented in different forms of hardware devices including, a wearable device (e.g., watch or glasses), a smart phone, a speaker device, a tablet device, or another hardware device. A client device can also include a digital media device, e.g., a streaming device that plugs into a television or other display to stream videos to the television, or a gaming device or console.

A client device 110 typically includes applications 112, such as web browsers and/or native applications, to facilitate the sending and receiving of data over the network 105. A native application is an application developed for a particular platform or a particular device (e.g., mobile devices having a particular operating system). Publishers 140 can develop and provide, e.g., make available for download, native applications to the client devices 110. A web browser can request a resource 145 from a web server that hosts a website 142 of a publisher 140, e.g., in response to the user of the client device 110 entering the resource address for the resource 145 in an address bar of the web browser or selecting a link that references the resource address. Similarly, a native application can request application content from a remote server of a publisher.

Some resources, application pages, or other application content can include digital component slots for presenting digital components with the resources 145 or application pages. As used throughout this document, the phrase “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files and include advertising information, such that an advertisement is a type of digital component. For example, the digital component may be content that is intended to supplement content of a web page or other resource presented by the application 112. More specifically, the digital component may include digital content that is relevant to the resource content (e.g., the digital component may relate to the same topic as the web page content, or to a related topic). The provision of digital components can thus supplement, and generally enhance, the web page or application content.

When the application 112 loads a resource (or application content) that includes one or more digital component slots, the application 112 can request a digital component for each slot. In some implementations, the digital component slot can include code (e.g., scripts) that cause the application 112 to request a digital component from a digital component distribution system that selects a digital component and provides the digital component to the application 112 for presentation to a user of the client device 110.

The application 112 can also include a user grouping engine 114. For example, a web browser can be configured to include a user grouping engine 114. The user grouping engine 114 can be part of the code (e.g., scripts) that is executed at the client device 110 when the application 112 is loaded therein. The user grouping engine 114 can be configured to associate the client device 110 with a particular website 142 and/or resource 145 that is presented at the application 112. That is, when the application 112 navigates to a particular resource, the application 112 can update a list of resources to which the application 112 has navigated to include the particular resource. This list can include resources to which the application 112 has navigated over a given time period, e.g., for the past week, two weeks, month, or another appropriate time period.

The user grouping engine 114 can use the list of resources to assign the user of the client device 110 to a user interest group. Each user interest group can include users that are determined to be similar, e.g., based on the resources visited by the users. For example, users that visit similar resources can be considered similar and assigned to the same user interest group. As another example, using machine learning algorithms and techniques, user interest groups can include users that visit same websites 142, select same or similar content on those pages, and/or other factors or contextual signals. As an illustrative example, a user interest group can be based on geographic location of the users that visit the website 142, another user interest group can be designated for users that visit a sale page on the website 142, another user interest group can be designated for users that put electronics in their shopping cart on the web site 142, another user interest group can be designated for users that search for items that can be picked up in store, etc. Each user interest group can also include a category, e.g., a category of interest for each user in the user interest group, and a user interest group identifier that uniquely identifies the user interest group. Importantly, the user grouping engine 114 can assign the user of the client device 110 to a user interest group at the client device 110 without providing any of the resource visitation information to another device or receiving information about any other user, thereby preserving user privacy.

Adding the user of the client device 110 to the user interest group can include assigning the user interest group identifier for the user interest group to the client device 110. The user grouping engine 114 can analyze the list of resources visited by the user on a recurring basis, e.g., periodically, to assign the user to a user interest group. Thus, the user interest group to which a user is assigned can change over time. However, the history of user interest groups for a user may not be maintained. Instead, the application 112 may only maintain the user interest group identifier for the current user interest group to which the user is assigned. This preserves the user's privacy with respect to user group membership over time.

When requesting a digital component from the content platform 150, the application 112 can provide, with a digital component request, the user interest group identifier rather than a user identifier that identifies the actual user of the client device 110. As a result, the client device 110 may not be identifiable by private or personal information of the user of the client device 110, thereby preserving user privacy. These user interest groups can be used in generation and expansion of user lists for other user groups for delivery of digital components, as described further below.

As mentioned above, generation of the user interest groupings or cohorts can be done at the client devices 110 and may not be uploaded elsewhere, which is beneficial to ensure user privacy. The user grouping engine 114 can ensure that groupings are well distributed to represent large quantities of users sharing similar interests. The larger the grouping, the less likely that any individual user can be tracked, thereby increasing and preserving user privacy. The user grouping engine 114 can also leverage anonymization methods, such as differential privacy, in order to further protect private information associated with users in the groupings. A SimHash algorithm, for example, can be applied to registrable domains of the websites 142 visited by users in order to cluster the users that visit similar websites 142. As another example, one or more federated learning methods can be used to estimate client models in a distributed fashion. The generated groupings can have similar browsing behaviors, and the identifier associated with the groupings, such as a user group identifier, can be used as a privacy-first replacement for pseudonymous identifiers used in serving digital components to client devices 110.

Digital component providers 170 can create (or otherwise publish) digital components that are displayed in digital component slots of publisher's resources and applications. The digital component providers 170 can use the content platform 150 to manage the provisioning of its digital components for presentation in digital component slots.

In general, the content platform 150 can receive a request for digital components (e.g., from client device 110), select a digital component 134 for presentation at the client device 110, and provide, to the client device 110, data that causes the client device 110 to present the digital component 134. For example, when a user navigates a web browser to a particular web page, the web browser can submit a content request 131 to the web servers that host the website that includes the web page. In response, the web server can provide the requested content 132, i.e. web page, to the web browser. If the web page includes one or more digital component slots, the code of these slots can cause the web browser to submit a digital component request 133 to the content platform 150.

In some implementations, the application 112 can include, in the digital component request 133, the user group identifier for the user interest group that includes the user as a member. In this way, the content platform 150 can select digital components 134 that are more likely to be of interest to the user based on the interest category corresponding to the user interest group and provide the digital components 134 to the web browser for display to the user.

In some implementations, the content platform 150 is also a content publisher or other online service provider. For example, the content platform 150 may publish, within native applications and/or web pages, news articles, videos, etc. In another example, the content platform 150 can provide e-mail services, host a video sharing site, etc. With this electronic content, the content platform 150 can select and display digital components 134 received from the digital component providers 170.

When the content platform 150 provides a service for which users log in or provide personal identifying information, the content platform 150 can use additional information about the user to select digital components 134. For example, the content platform 150 can use data included in a user profile for the user to select relevant digital components 134 for display to the user. The user profile can include information about the user, such as demographic information, geographic location of the user, information identifying electronic resources and/or other content requested and/or viewed by the user at the content platform, and information identifying any user lists that include the user as a member, e.g., user action groups to which the user was assigned using similar audience models, as described below.

The content platform 150 can manage the membership of user groups other than the user interest groups. One example user group is a user action group, e.g., a remarketing group, that includes users that performed one or more particular actions at an electronic resource. For example, each user that selected a particular item, e.g., a daisy, can be added to a user action group with a category of daisies. In this example, a user is considered to be interested in daisies based on the user performing a particular action related to daisies, e.g., selecting the daisy at the electronic resource. A user list for a user action group can include the user identifier for each user that performed the particular action, e.g., over a given time period.

However, user identifiers for users may not be provided to the content platform 150 unless the user is logged into an account of theirs at the content platform 150. Thus, the quantity of users in these user action groups may be limited without the use of third-party cookies or the techniques for expanding such groups described in this document.

The content platform 150 can maintain user group data 152 and user list data 154. The user group data 152 can include, for each user, a user identifier that uniquely identifies the user to the content platform 150 and the user interest group identifier for the user interest group that includes the user as a member, if any.

The user list data 154 can include user lists for user groups and, for each user list, user identifiers for users that are members of the user group corresponding to the user list. The user lists can include user lists for user action groups.

The content platform 150 can interact with an audience expansion server 160 to generate and/or expand the user lists. The audience expansion server 160, which is also referred to as an expansion server 160 for brevity, can generate a user list for a user group using user group data 171, which can include all or a subset of the user group data 152, received from the content platform 150.

The expansion server 160 can generate, e.g., train, and use similar audience models to generate and/or expand user lists that include users that are considered similar to users. The expansion server 160 can also generate similar audience models to generate and/or expand user lists that include users that are considered similar to groups of users, e.g., user interest groups, that include one or more members that performed one or more particular action(s) at electronic resources.

In some implementations, the expansion server 160 generates the similar audience model(s) using a seed user list 164. The expansion server 160 can generate a seed user list 164 for a user group, e.g., a user action group, based on members of a set of user interest groups 162. The set of user interest groups 162 can include the user interest groups that have at least one member that performed a particular action corresponding to the user action group.

In some implementations, digital component providers can embed, into their web pages, native applications, or other electronic resources, web tags or other code to report the user interest group identifiers of users that perform one or more particular actions at electronic resources of the digital component provided. The code can be configured to transmit, to the digital component provider or the content platform 150, the user interest group identifier for the user interest group that includes, as a member, the user in response to the user performing the particular action(s) at the electronic resource. For example, the code can request the user interest group identifier from the application 112 that maintains the user interest group identifier for the user, and transmit the user interest group identifier to the digital component provider or content platform 150 in response to detecting the occurrence of the particular action(s).

In this way, the digital component provider and/or the content platform 150 (e.g., by receiving the data from the digital component provider) can determine a quantity of users of each user interest group that performed the particular action(s) over a given time period. For example, the content platform 150 can build a histogram that shows the quantities for the user interest groups.

In a particular example, assume that the particular action for a given user action group is adding a particular item to a virtual cart. A first user that is a member of a first user interest group navigates to the web page of the digital component provider and adds the particular item to the cart. In this example, the web tag would report the user interest group identifier for the first user interest group to the digital component provider. The digital component provider or content platform 150 can then update a count of the number of users in the first user interest group that added the particular item to their virtual cart by incrementing the count by one.

The counts for each user interest groups can be for a particular time period, which can be the same for each user interest group being considered for a user action group or different. For example, the time period for a user interest group can be a time period that ends at a time that a last particular action occurred for at least one member of the user interest group and that starts a predefined duration, e.g., one week, two days, etc., prior to the occurrence of the last particular action.

The expansion server 160 can use the counts to generate the seed user list 164 for the user action group. For example, the expansion server 160 can select one or more of the user interest groups based on the counts and generate the seed user list 164 using data for the one or more user interest groups. In a particular example, the expansion server 160 can select a predefined number of user interest groups having the highest counts. In another example, the expansion server 160 can select the user interest groups that have at least a threshold count. In another example, the expansion server 160 can select the user interest groups that have the highest counts and that make up at least a threshold percentage of the occurrences of the particular action(s). For example, assume there are ten user interest groups that all include at least one member that performed the particular action(s) and the threshold percentage is 50%. If a combination of the top two user interest groups represent 50% or more of the occurrences of the particular action(s), the expansion server 160 can select those two user interest groups for use in generating the seed user list 164.

The expansion server 160 can generate, as the seed user list 164, the users that are in the selected user interest groups and for which a user identifiers for the users are known. The expansion server 160 can use the user group data 171 to identify the user identifiers for these users. As described above, the user group data 171 can include the user identifiers for the members of each user interest group. These user identifiers can be the user identifiers that are used by the content platform 150 to identify the users, e.g., when the users are logged into a service provided by the content platform 150.

The expansion server 160 can then generate, e.g., train, a similar audience machine learning model 166 using the information for the users in the seed user list 164. The similar audience machine learning model 166 can be in the form of a neural network, a nearest neighbors model, e.g., a k-nearest neighbors (KNN) model, a centroid model, or another appropriate data processing model that can be used to identify users that are similar to the users in the seed user list 164. The information for the users in the seed user list 164 can include the information stored in the user profiles for the users, e.g., demographic information, geographic location of the user, information identifying electronic resources and/or other content requested and/or viewed by the user at the content platform, and information identifying any user lists that include the user as a member, etc.

The expansion server 160 can use the similar audience machine learning model 166 to expand the seed user list 164 to include additional users that are classified as being similar to the users in the seed user list 164. For example, the expansion server 160 can provide information about additional users, e.g., feature values for features of the additional users, as input to the similar audience machine learning model 166. The expansion server 160 can process the similar audience machine learning model 166 using the information for each additional user to classify the additional user as a similar user or a non-similar user. The expansion server 160 can include, in the expanded user list 168, each additional user classified as being a similar user. In another example, the similar audience machine learning model 166 can output a score that represents the likelihood that the additional user is a similar user or a measure of similarity between the additional user and the users in the seed user list 164. In this example, the similar audience machine learning model 166 can include, in the expanded user list 168, each additional user that has a score or measure of similarity that satisfies a threshold score, e.g., by meeting or exceeding the threshold score.

The expansion server 160 can provide the expanded user list(s) 168 to the content platform 150. The content platform 150 can use the expanded user list(s) 160 to select content for users. When there is an opportunity to display a digital component with content provided by the content platform and the content platform 150 has access to the user identifier for the user to which the content is being provided, e.g., based on the user being logged into a service provided by the content provider 150, the content provider 150 can determine whether the user is a member of an expanded user list. For example, the content platform 150 can compare the user identifier that identifies the user to the content platform 150 to each expanded user list 168 and/or determine whether the user profile for the user includes user group identifiers for expanded user lists 168. If so, the content platform 150 can provide a digital component related to the user group that corresponds to the expanded user list(s) 168 that include the user's identifier. For example, if the user was added to an expanded user list 168 for a particular brand tennis shoe, the content platform 150 can provide a digital component for the particular brand tennis shoe to the client device 110 of the user for display with content provided by the content platform 150. Further to the descriptions throughout this document, a user may be provided with controls (e.g., user interface elements with which a user can interact) allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

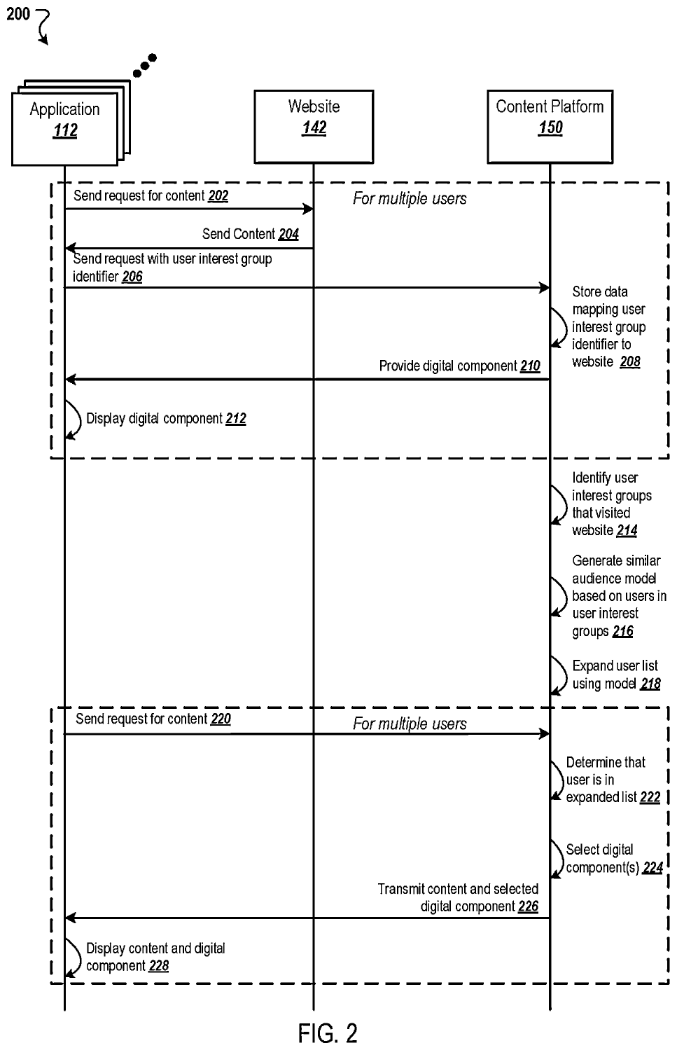

FIG. 2 is a swim lane diagram that illustrates an example process 200 for expanding a user group and distributing content based on the expanded user group. Operations of the process 200 can be implemented, for example, by an application, e.g., a web browser or native application running on a client device, a web server that hosts a website, and a content platform, e.g., the application 112, website 142, and content platform 150, respectively, of FIG. 1. Operations of the process 200 can also be implemented as instructions stored on one or more computer readable media which may be non-transitory, and execution of the instructions by one or more data processing apparatus can cause the one or more data processing apparatus to perform the operations of the process 200.

In this example process, the content platform 150 generates and expands a user list for a user action group for users that visit a particular website. The particular action for the user action group is visiting the website, e.g., navigating to the website using a web browser application. The process 200 can be used for other types of actions, e.g., selecting particular items on electronic resources, interacting with particular content items on resources, etc.

An application 112 running on a client device 110 sends a request for content to a website 142 (202). The website 142 sends the content to the application 112 (204). The application 112 can be a web browser or native application. Although a website is shown in this example, the content can be content for a native application obtained from a remote server that provides the content for the native application in response to requests.

The application sends a request that includes a user interest group identifier for the user to a content platform 150 (206). For example, the website 142 can include a tag or other code that causes the application 112 to obtain the user interest group identifier for the user and send the user interest group identifier to the content platform 150 and/or to the web server hosting the website 142. The user interest group identifier identifies the user interest group to which the user has been assigned, e.g., by a user grouping engine of the application 112 or client device 110, as described above.

In this example, the code causes the application 112 to send the user interest group identifier along with a request for one or more digital components. For example, the code can be for a digital component slot included in a web page of the website 142.

In another example, the code can cause the application 112 to send the user interest group identifier for the user to the web server that hosts the website 142. In this example, the electronic resource can include a code that causes the application 112 to report the user interest group identifier for the user to the web server, e.g., so that the web server can customize content for the user. In such examples, the web server can perform operations 208 and 214 of the process 200.

The content platform 150 stores data mapping user group identifiers to the website 142 (208). For example, the content platform 150 can maintain a table or database that links the website 142 to each user interest group identifier for which a member visited the website 142. The content platform 150 can also store, for each visit, a time at which the visit occurred. The content platform 150 can use this information to determine a count of the number of times members of each user interest group visited the website 142, e.g., over a given time period. In another example, the content platform 150 can maintain such count without the use of a table, e.g., by incrementing the count each time a member of a user interest group visits the website 142.

The content platform 150 provides, to the application 112, a digital component in response to the request (210). The content platform 150 can select the digital component based at least in part on the user interest group for the user. The content platform 150 can also select the digital component based on contextual information included in the request, e.g., the resource locator (e.g., URL or URI) of the website 142, the geographic location of the client device 110, etc.

If the user is logged into a service of the content platform 150 such that the website 142 is a website of the content platform 150, the content platform 150 may have access to a user identifier that identifies the user to the content platform 150. In such cases, the content platform 150 can use additional information about the user, e.g. information stored in a user profile for the user that is maintained by the content platform 150. As described above, such information can include demographic information, geographic location of the user, information identifying electronic resources and/or other content requested and/or viewed by the user at the content platform, and information identifying any user lists that include the user as a member, e.g., user action groups to which the user was assigned using similar audience models.

The application 112 receives the digital component and displays the digital component, e.g., with the website (212). In some cases, the request can be for multiple digital components. In such cases, the content platform 150 can select multiple digital components and provide them to the application 112 in a similar manner.

The operations 202-212 can be performed for multiple users to generate the mappings between the user group identifiers and websites. For example, the content platform 150 can maintain the mapping data for multiple user action groups that have corresponding particular action(s).

The content platform 150 identifies user interest groups that visited the website 142, i.e., user interest groups for which members performed the particular action for the user action group (214). The content platform 150 can determine, for each such user interest group, a count of the number of members of each user interest group that visited the website 142 over a given time period using the mapping between the user interest groups and the website stored in operation 208. The time period for each user interest group can end at a time at which the last member visited the website 142 and begin a predefined duration of time prior to the time at which the last member visited the website 142. In another example, the time period for all user interest groups can be the same, e.g., the previous week, the previous 24 hours, the last hour, etc.

The content platform 150 generates a similar audience model based on information for users in at least one or more of the user interest groups that visited the website (216). As described above, the similar audience machine learning model can be in the form of a neural network, a nearest neighbors model, e.g., a (KNN) model, a centroid model, or another appropriate data processing model.

To generate the similar audience model, the content platform 150 can generate a seed user list based on the user interest groups that visited the website 142. The content platform 150 can generate, as the seed user list, the users that are in the selected user interest groups and for which user identifiers for the users are known. The content platform 150 can use a mapping between user identifiers for users of the content platform 150 and their user interest groups to identify actual users that are members of the user interest groups that visited the website 142. These user identifiers identify the users to the content platform, e.g., when the users are logged into services provided by the content platform 150.

The seed user list can include each user that is a member of a user interest group that visited the website 142 and for which a user identifier is available to the content platform 150. In some implementations, the content platform 150 filters users from this seed list. For example, as described above, the content platform 150 can use the counts for each user interest group to generate the seed user list. The content platform 150 can select one or more of the user interest groups based on the counts and generate the seed user list using data for the one or more user interest groups. In a particular example, the content platform 150 can select a predefined number of user interest groups having the highest counts. In another example, the content platform 150 can select the user interest groups that have at least a threshold count. In another example, the content platform 150 can select the user interest groups that have the highest counts and that make up at least a threshold percentage of the occurrences of the particular action(s).

The content platform 150 can also filter the seed user list based on other information. For example, the content platform 150 can filter users based on geographic location such that only users in one or more particular geographic locations are included in the seed user list.

The content platform 150 trains the similar audience model using information for the users in the seed user list. In some implementations, the content platform 150 trains the similar audience model using one or more features for each user interest group included in the seed user list. For example, the content platform 150 can compute, for each of these user interest groups, a single feature value for a single feature that represents all users in the user interest group. The content platform 150 can then train the similar audience model using the feature value for each user interest group represented by the seed user list. The single feature for each user interest group can be, for example, the most frequently occurring feature for the user interest group. For example, the content platform 150 can use a set of features to consider, such as location, age, gender, language, content requested by the user, etc. For each of these features, the content platform 150 can identify, for each user interest group, the most frequently occurring feature value among the features and use this as the feature value for the feature that represents the user interest group in training the similar audience model.

In another example, the single feature for each user interest group can be an average feature across the users, e.g., all users, in the user interest group. For example, the single feature can be the average age of the users in the user interest group. For multivalent categorical features (e.g., search query categories), the single feature can be the top K most frequent values to generate a new multivalent feature value.

In some implementations, the content platform 150 trains the similar audience model using feature values of features of all users in the seed user list. The content platform 150 can also sample the users in the seed list based on one or more criteria and use the feature values of the sampled seed user list to train the similar audience model.

In some implementations, the content platform 150 generates subclusters of users within each user interest group of the seed user list and trains the similar audience model using the subclusters. For example, the content platform 150 can learn the subclusters based on feature values for features of each user in the seed user list. The content platform 150 can use various clustering techniques, such as affinity or k-means. The content platform 150 can then compute one or more feature values for one or more features that represent each subcluster. The content platform 150 can then train the similar audience model using the feature value(s) of the feature(s) for each subcluster.

In some implementations, the content platform 150 can assign weights to each user. The weights for a user can represent how likely the user is to be included in, e.g., register for, the seed user list. The sum of these weights for a user interest group can equal the number of users from the user interest group that are included in the seed user list. The content platform 150 can start with uniform weights in a given user interest group and train a similar audience model based on the feature values and weights for the users in the given user interest group. The content platform 150 can then apply the similar audience model to the users in the associated user interest groups that have at least one member in the seed user list. By doing this, the content platform 150 can reweight the users in the given user interest group (e.g., to more heavily favor the users that align with the overall similar audience model), and then retrain the model based on the updated weightings. The content platform 150 can repeat this reweighting and retraining process multiple times to get a more specific similar audience model that effectively sheds the influence of users from registering user interest groups that do not fit in well with the aggregate similar audience model.

In another example, each registration of a user into a user interest group can come with a resource locator (e.g., URL or URI) that determines a topic model for the registration. In addition, each user interest group can be clustered based on search history vectors. Instead of adding the whole user interest group to the seed user list, the content platform 150 can only add the subcluster of user interest groups which are the closest to the webpage or other resource where the registration event happened. For example, if there is a registration event on a baby food webpage, and there is a subcluster of a user interest group for which the members search for baby food, then the content platform can focus only on that subcluster when training the similar audience model, e.g., either by weighting the subcluster higher than other subclusters or by using members of that subcluster only.

The content platform 150 can train the similar audience model using the computed feature values for the features of the users or subclusters. For a centroid model, the content platform 150 can compute the centroid for the feature values and the centroid represents the average user of the user action group for which the user list is being generated and expanded.

The content platform 150 expands the seed user list using the similar audience model (218). For example, the content platform 150 can process the similar audience model using feature values of features of additional users to classify the additional users as similar users or non-similar users, as described above. The content platform 150 can add each similar user to the user list to generate the expanded user list. That is, the expanded user list can include the users in the seed user list and the users classified as being similar users using the similar audience model.

An application 112 running on a client device 110 sends a request for content to the content platform 150 (220). For example, a user can log into a service provided by the content platform 150 can request content from the content platform 150. In such cases, the content platform 150 has access to the user identifier that identifies the user to the content platform 150.

The content platform 150 determines whether the user is included in a user list, e.g., an expanded user list generated using a similar audience model (222). For example, the content platform 150 can compare the user identifier for the user to multiple user lists or evaluate the user profile for the user to determine whether any user group identifiers are included in the user profile for the user.

The content platform 150 selects one or more digital components to display to the user (224). The content platform 150 can select the digital component(s) based on the user groups that include the user as a member, if any. For example, if the user is included in a user list for a user group related to an author, the content platform 150 can select a digital component that includes content related to the author, e.g., content of a new book published by the author. By using the user groups in this way, network bandwidth is reduced and computational resources that would typically be used to send and receive cookies are reduced, as well as power of the involved devices being preserved. For example, rather than receiving and evaluating a cookie for selecting the digital component(s), the content platform 150 can select one much quicker using the user list(s) that include the user.

The content platform 150 transmits the requested content and selected digital component(s) to the application 112 (226). The application displays the content and digital component(s) to the user (228).

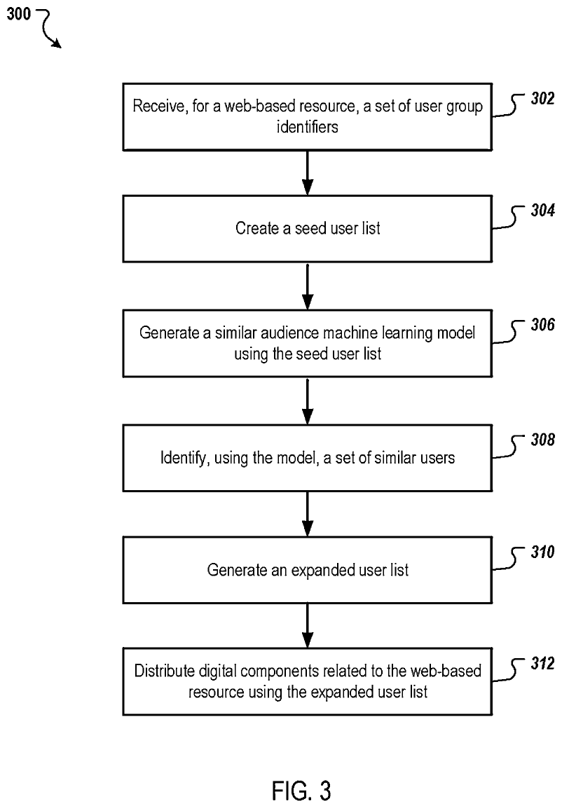

FIG. 3 is a flow diagram of an example process 300 for expanding a user group and distributing digital components using the expanded user list. Operations of the process 300 can be implemented, for example, by a content platform, e.g., the content platform 150 of FIG. 1. Operations of the process 300 can also be implemented as instructions stored on one or more computer readable media which may be non-transitory, and execution of the instructions by one or more data processing apparatus can cause the one or more data processing apparatus to perform the operations of the process 300. For brevity, the process 300 is described as being performed by the content platform 150, which can be implemented using one or more computers in one or more locations.

The content platform 150 receives, for a web-based resource, a set of user group identifiers for a set of user interest groups that each include, as members, one or more users that requested content from the web-based resource over a given time period (302). Each user interest group includes multiple users that have been classified as being interested in a category of the user interest group. The web-based resource can include a website, native application content, or other electronic resource accessible over the Internet or a mobile network. The content platform 150 can obtain the data using web tags embedded in the web-based resources, as described above.

The content platform creates a seed user list that includes user identifiers for at least a portion of the users in the set of user interest groups (304). As described above, the seed user list can include users that are members of at least some of the user interest groups and for which user identifiers for the users are available to the content platform 150.

The content platform 150 generates a similar audience machine learning model based on a set of one or more feature values corresponding to one or more features of the users corresponding to the user identifiers in the seed user list (306). As described above, the similar audience model can be a neural network, a nearest neighbors model, e.g., a KNN model, a centroid model, or another appropriate data processing model. The similar audience model can be trained using the process 200 of FIG. 2.

The content platform 150 identifies, using the similar audience machine learning model, a set of similar users that are classified as being similar to the users corresponding to the user identifiers in the seed user list (308). For example, the content platform 150 can process the similar audience model using feature values for features of additional users as input to the similar audience model. The similar audience model can output a classification as to whether each user is a similar user or a score or measure of similarity to the users of the seed user list used to train the similar audience model.

The content platform 150 generates an expanded user list that includes the user identifiers of the seed user list and the user identifiers of the set of similar users (310). For example, the content platform 150 can add the users that are classified as being similar to the seed user list to generate an expanded user list that includes the users of the seed user list and the similar users. By generating such an expanded list, network bandwidth is reduced and computational resources that would typically be used to send and receive cookies are reduced, as well as power of the involved devices being preserved. The expanded user list can then be used to select and distribute content rather than third-party cookies, which provides similar advantages at content selection time. Obviating the need for third-party cookies in this way can reduce/prevent delays in sending content to client devices. Further advantages in avoiding delays in providing content, e.g., digital components, in response to requests are avoiding page load errors at client devices or causing portions of an electronic document to remain unpopulated even after other portions of the electronic document are displayed at client devices.

The content platform 150 distributes digital content related to the web-based resource to the users corresponding to the user identifiers in the expanded user list based on the users being in the expanded user list (312). When the content platform 150 has access to a user identifier for a user that is requesting content, e.g., when the user is logged into a service provided by the content platform 150, the content platform 150 can use the user identifier to determine whether the user is included in a user list. If so, the content platform 150 can select digital content, e.g., digital components, related to the user list(s) that include the user identifier for the user. The content platform 150 can provide the selected digital content to the client device of the user for display to the user.

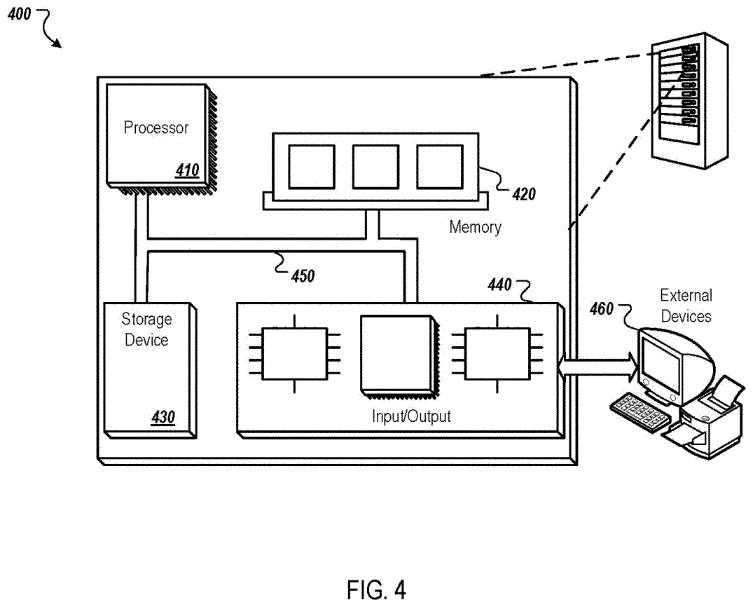

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In some implementations, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In some implementations, the memory 420 is a volatile memory unit. In another implementation, the memory 420 is a non-volatile memory unit.

The storage device 430 is capable of providing mass storage for the system 400. In some implementations, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In some implementations, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to external devices 460, e.g., keyboard, printer and display devices. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML, page) to a client device (e.g., for purposes of displaying data to and receiving user input from a user interacting with the client device). Data generated at the client device (e.g., a result of the user interaction) can be received from the client device at the server.

In addition to the embodiments described above, the following embodiments are also innovative:

Embodiment 1 is a method comprising receiving, for a web-based resource, a set of user group identifiers for a set of user interest groups that each include, as members, one or more users that requested content from the web-based resource over a given time period, wherein each user interest group includes a plurality of users that have been classified as being interested in a category of the user interest group; creating a seed user list that includes user identifiers for at least a portion of the users in the set of user interest groups; generating a similar audience machine learning model based on a set of one or more feature values corresponding to one or more features of the users corresponding to the user identifiers in the seed user list; identifying, using the similar audience machine learning model, a set of similar users that are classified as being similar to the users corresponding to the user identifiers in the seed user list; generating an expanded user list comprising the user identifiers of the seed user list and the user identifiers of the set of similar users; and distributing digital content related to the web-based resource to the users corresponding to the user identifiers in the expanded user list based on the users being in the expanded user list.

Embodiment 2 is the method of embodiment 1, wherein receiving the set of user group identifiers comprises: receiving, from a client device, a request for content of the web-based resource; providing, to the client device, the content comprising code that causes the client device to return a user group identifier for a user group that includes a user of the client device as a member; and in response to the user requesting the content of the web-based resource, adding, to the set of user group identifiers, the user group identifier for the user group that includes the user of the client device as a member.

Embodiment 3 is the method of embodiment 1 or 2, wherein the similar audience model comprises at least one of a neural network, a centroid model, or a k-nearest neighbors model.

Embodiment 4 is the method of any one of embodiments 1-3, wherein creating a seed user list comprises: determining, for each user interest group in the set of user interest groups, a quantity of requests for content the web-based resource received from members of the user interest group over the given time period; and selecting a proper subset of the set of user interest groups based on the quantity for each user interest group in the set of user interest groups; and including, in the seed user list, each user identifier of each user interest group in the subset of user interest groups.

Embodiment 5 is the method of any one of embodiments 1-4, wherein generating the similar audience machine learning model based on the set of one or more feature values corresponding to one or more features of the users corresponding to the user identifiers in the seed user list comprises: identifying, for each user interest group, a respective feature value for a respective feature of the user interest group based on the feature values for the users in the user interest group; and training the similar audience machine learning model using the respective feature value for each user interest group in the set of user interest group.

Embodiment 6 is the method of any one of embodiments 1-5, wherein generating the similar audience machine learning model based on the set of one or more feature values corresponding to one or more features of the users corresponding to the user identifiers in the seed user list comprises: identifying all feature values of all users in the seed user list; and training the similar audience machine learning model using all feature values of all users in the seed user list.

Embodiment 7 is the method of any one of embodiments 1-6, wherein generating the similar audience machine learning model based on the set of one or more feature values corresponding to one or more features of the users corresponding to the user identifiers in the seed user list comprises: generating, for a given user interest group, multiple clusters of users based on feature values for each user that is a member of the given user interest group; generating, for each cluster, a respective feature value for a feature of the cluster; and training the similar audience machine learning model using the feature value for each cluster.

Embodiment 8 is a system, comprising: one or more processors; and one or more computer-readable media storing instructions that, when executed by the one or more processors, cause the one or more processors to perform the method of any one of embodiments 1-7.

Embodiment 9 is a computer-readable medium, which may be non-transitory, comprising instructions that, when executed by a processor, cause the processor to perform the method of any one of embodiments 1-7.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, for a web-based resource, a set of user group identifiers for a set of user interest groups that each include, as members, one or more users that requested content from the web-based resource over a given time period, wherein each user interest group includes a plurality of users that have been classified as being interested in a category of the user interest group;
creating a seed user list that includes user identifiers for at least a portion of the users in the set of user interest groups;
generating a similar audience machine learning model based on a set of one or more feature values corresponding to one or more features of the users corresponding to the user identifiers in the seed user list;
identifying, using the similar audience machine learning model, a set of similar users that are classified as being similar to the users corresponding to the user identifiers in the seed user list;
generating an expanded user list comprising the user identifiers of the seed user list and the user identifiers of the set of similar users; and
distributing digital content related to the web-based resource to the users corresponding to the user identifiers in the expanded user list based on the users being in the expanded user list.

2. The computer-implemented method of claim 1, wherein receiving the set of user group identifiers comprises:
receiving, from a client device, a request for content of the web-based resource;
providing, to the client device, the content comprising code that causes the client device to return a user group identifier for a user group that includes a user of the client device as a member; and
in response to the user requesting the content of the web-based resource, adding, to the set of user group identifiers, the user group identifier for the user group that includes the user of the client device as a member.

3. The computer-implemented method of claim 1, wherein the similar audience model comprises at least one of a neural network, a centroid model, or a k-nearest neighbors model.

4. The computer-implemented method of claim 1, wherein creating a seed user list comprises:
determining, for each user interest group in the set of user interest groups, a quantity of requests for content the web-based resource received from members of the user interest group over the given time period; and
selecting a proper subset of the set of user interest groups based on the quantity for each user interest group in the set of user interest groups; and
including, in the seed user list, each user identifier of each user interest group in the subset of user interest groups.

5. The computer-implemented method of claim 1, wherein generating the similar audience machine learning model based on the set of one or more feature values corresponding to one or more features of the users corresponding to the user identifiers in the seed user list comprises:
identifying, for each user interest group, a respective feature value for a respective feature of the user interest group based on the feature values for the users in the user interest group; and
training the similar audience machine learning model using the respective feature value for each user interest group in the set of user interest group.

6. The computer-implemented method of claim 1, wherein generating the similar audience machine learning model based on the set of one or more feature values corresponding to one or more features of the users corresponding to the user identifiers in the seed user list comprises:
identifying all feature values of all users in the seed user list; and
training the similar audience machine learning model using all feature values of all users in the seed user list.

7. The computer-implemented method of claim 1, wherein generating the similar audience machine learning model based on the set of one or more feature values corresponding to one or more features of the users corresponding to the user identifiers in the seed user list comprises:
generating, for a given user interest group, multiple clusters of users based on feature values for each user that is a member of the given user interest group;
generating, for each cluster, a respective feature value for a feature of the cluster; and
training the similar audience machine learning model using the feature value for each cluster.

8. A system, comprising:
one or more processors; and
one or more computer-readable media storing instructions that, when executed by the one or more processors, cause the one or more processors to perform operations comprising:
receiving, for a web-based resource, a set of user group identifiers for a set of user interest groups that each include, as members, one or more users that requested content from the web-based resource over a given time period, wherein each user interest group includes a plurality of users that have been classified as being interested in a category of the user interest group;
creating a seed user list that includes user identifiers for at least a portion of the users in the set of user interest groups;
generating a similar audience machine learning model based on a set of one or more feature values corresponding to one or more features of the users corresponding to the user identifiers in the seed user list;
identifying, using the similar audience machine learning model, a set of similar users that are classified as being similar to the users corresponding to the user identifiers in the seed user list;
generating an expanded user list comprising the user identifiers of the seed user list and the user identifiers of the set of similar users; and
distributing digital content related to the web-based resource to the users corresponding to the user identifiers in the expanded user list based on the users being in the expanded user list.

9. The system of claim 8, wherein receiving the set of user group identifiers comprises:
receiving, from a client device, a request for content of the web-based resource;
providing, to the client device, the content comprising code that causes the client device to return a user group identifier for a user group that includes a user of the client device as a member; and
in response to the user requesting the content of the web-based resource, adding, to the set of user group identifiers, the user group identifier for the user group that includes the user of the client device as a member.

10. The system of claim 8, wherein the similar audience model comprises at least one of a neural network, a centroid model, or a k-nearest neighbors model.

11. The system of claim 8, wherein creating a seed user list comprises:
determining, for each user interest group in the set of user interest groups, a quantity of requests for content the web-based resource received from members of the user interest group over the given time period; and
selecting a proper subset of the set of user interest groups based on the quantity for each user interest group in the set of user interest groups; and
including, in the seed user list, each user identifier of each user interest group in the subset of user interest groups.

12. The system of claim 8, wherein generating the similar audience machine learning model based on the set of one or more feature values corresponding to one or more features of the users corresponding to the user identifiers in the seed user list comprises:
identifying, for each user interest group, a respective feature value for a respective feature of the user interest group based on the feature values for the users in the user interest group; and
training the similar audience machine learning model using the respective feature value for each user interest group in the set of user interest group.

13. The system of claim 8, wherein generating the similar audience machine learning model based on the set of one or more feature values corresponding to one or more features of the users corresponding to the user identifiers in the seed user list comprises:
identifying all feature values of all users in the seed user list; and
training the similar audience machine learning model using all feature values of all users in the seed user list.

14. The system of claim 8, wherein generating the similar audience machine learning model based on the set of one or more feature values corresponding to one or more features of the users corresponding to the user identifiers in the seed user list comprises:
generating, for a given user interest group, multiple clusters of users based on feature values for each user that is a member of the given user interest group;
generating, for each cluster, a respective feature value for a feature of the cluster; and
training the similar audience machine learning model using the feature value for each cluster.

15. A non-transitory computer-readable medium comprising instructions that, when executed by a processor, cause the processor to perform operations comprising:
receiving, for a web-based resource, a set of user group identifiers for a set of user interest groups that each include, as members, one or more users that requested content from the web-based resource over a given time period, wherein each user interest group includes a plurality of users that have been classified as being interested in a category of the user interest group;
creating a seed user list that includes user identifiers for at least a portion of the users in the set of user interest groups;
generating a similar audience machine learning model based on a set of one or more feature values corresponding to one or more features of the users corresponding to the user identifiers in the seed user list;
identifying, using the similar audience machine learning model, a set of similar users that are classified as being similar to the users corresponding to the user identifiers in the seed user list;
generating an expanded user list comprising the user identifiers of the seed user list and the user identifiers of the set of similar users; and
distributing digital content related to the web-based resource to the users corresponding to the user identifiers in the expanded user list based on the users being in the expanded user list.

16. The non-transitory computer-readable medium of claim 15, wherein receiving the set of user group identifiers comprises:
receiving, from a client device, a request for content of the web-based resource;
providing, to the client device, the content comprising code that causes the client device to return a user group identifier for a user group that includes a user of the client device as a member; and
in response to the user requesting the content of the web-based resource, adding, to the set of user group identifiers, the user group identifier for the user group that includes the user of the client device as a member.

17. The non-transitory computer-readable medium of claim 15, wherein the similar audience model comprises at least one of a neural network, a centroid model, or a k-nearest neighbors model.

18. The non-transitory computer-readable medium of claim 15, wherein creating a seed user list comprises:
determining, for each user interest group in the set of user interest groups, a quantity of requests for content the web-based resource received from members of the user interest group over the given time period; and
selecting a proper subset of the set of user interest groups based on the quantity for each user interest group in the set of user interest groups; and
including, in the seed user list, each user identifier of each user interest group in the subset of user interest groups.

19. The non-transitory computer-readable medium of claim 15, wherein generating the similar audience machine learning model based on the set of one or more feature values corresponding to one or more features of the users corresponding to the user identifiers in the seed user list comprises:
identifying, for each user interest group, a respective feature value for a respective feature of the user interest group based on the feature values for the users in the user interest group; and
training the similar audience machine learning model using the respective feature value for each user interest group in the set of user interest group.

20. The non-transitory computer-readable medium of claim 15, wherein generating the similar audience machine learning model based on the set of one or more feature values corresponding to one or more features of the users corresponding to the user identifiers in the seed user list comprises:
identifying all feature values of all users in the seed user list; and
training the similar audience machine learning model using all feature values of all users in the seed user list.
